(19) United States
(12) Patent Application Publication
(10) Pub. No.: US 2019/0238784 A1
(43) Pub. Date: Aug. 1, 2019

(54) TELEVISION SIGNAL RECEIVING APPARATUS IN FREQUENCY DIVISION FULL-DUPLEX SATELLITE TELEVISION SYSTEM

(71) Applicant: MStar Semiconductor, Inc., Hsinchu Hsien (TW)

(72) Inventors: Yu-Che SU, Hsinchu Hsien (TW); Tai-Lai TUNG, Hsinchu Hsien (TW)

(21) Appl. No.: 15/957,088

(22) Filed: Apr. 19, 2018

(30) Foreign Application Priority Data
Feb. 1, 2018 (TW) 107103693

(51) Int. Cl. H04N 5/44; H04N 5/455

(52) U.S. Cl. CPC H04N 5/4401; H04N 5/455

(57) ABSTRACT

A television signal receiving apparatus cooperating with a front-end circuit in a frequency division full-duplex satellite television system is provided. A digital-to-analog conversion circuit receives a request signal to be sent to the front-end circuit, and outputs an analog request signal. A multi-node low-pass filter has a first node, a second node and a third node. The first node is electrically coupled to an output end of the digital-to-analog conversion circuit. The third node is electrically coupled to the front-end circuit. The multi-node low-pass filter filters out high-frequency signals coupled from the first node and the third node to the second node, and further filters out high-frequency signals coupled from the first node to the third node. A command parsing circuit receives a filtered signal from the second node, and processes and parses the filtered signal.

This application claims the benefit of Taiwan application Serial No. 107103693, filed Feb. 1, 2018, the subject matter of which is incorporated herein by reference.

### BACKGROUND OF THE INVENTION

### Field of the Invention

The invention relates to a satellite television, and more particularly to a user-terminal television signal receiving apparatus in a frequency division full-duplex satellite television system.

### Description of the Related Art

A dish antenna for satellite television is usually shared by multiple television sets in a same building. FIG. 1 shows a function block diagram of a satellite television receiving end. Television signals received by a dish antenna are first forwarded to a front-end circuit 120 for preliminary processing such as demodulation and low-noise down-conversion. Multiple television signal receiving apparatuses 140 are connected to the front-end circuit 120 via a cable 130. In practice, the television signal receiving apparatuses 140 may be set-top boxes (STBs), or may be television devices built-in with an STB function. An operation process of the television signal receiving apparatus 140 is given in brief below. After activation, the television signal receiving apparatus 140 sends a registration request to the dish antenna 110 via the front-end circuit 120. If the registration is successful, the television signal receiving apparatus 140 receives system related information via the front-end circuit 120. According to the system related information, the television signal receiving apparatus 140 configures (e.g., setting carrier frequencies) circuits related to signal demodulation. Once the configuration is complete, the television signal receiving apparatus 140 sends a channel selection request to the dish antenna 110, and receives corresponding television signals from the dish antenna 110 via the front-end circuit 120.

If a frequency division full-duplex system structure is used, following signals are configured to be simultaneously transmitted at different frequency bands through the cable 130: television signals sent by the front-end circuit 120 to the television signal receiving apparatus 140, communication signals (e.g., informing the television signal receiving apparatus 140 of an exclusive frequency band the television signals belongs to or the foregoing system related information after the television signal receiving apparatus 140 has been activated) sent by the dish antenna 110 to the television signal receiving apparatus 140, and request signals (e.g., the foregoing registration request or channel selection request) sent by the television signal receiving apparatus 140 to the dish antenna 110. For example, in a current satellite television system, the television signals sent by the front-end circuit 120 are carried in a frequency band near 1 GHz, the communication signals sent by the dish antenna 110 to the television signal receiving apparatus 140 are carried in a frequency band near 6.5 MHz, and the request signals sent by the television signal receiving apparatus 140 to the dish antenna 110 are carried in a frequency band near 4.5 MHz. An example using the above frequency allocation is described below.

FIG. 2 shows a partial circuit function block diagram of the television signal receiving apparatus 140. A request generating circuit 141 is a transmitting circuit in the television signal receiving apparatus 140, and includes an information processing circuit 141A, a mixer 141B, a digital-to-analog converter (DAC) 141C and a low-pass filter (LPF) 141D. To send a request to the dish antenna 110, the information processing circuit 141A provides a string of data bits representing a request signal to the mixer 312 and the DAC 313 to convert to an analog signal carried at 4.5 MHz. The low-pass filter 141D prevents high-frequency harmonics of the analog signal from interfering other circuits. Assuming that the frequency of the second harmonics of the analog signal is 13.5 MHz, the low-pass filter 141D may be designed to filter out signals above 8 MHz.

A diplexer 142, a command parsing circuit 143 and a television signal parsing circuit 144 are a receiving circuit in the television signal receiving apparatus 140. The diplexer 142 may be considered as including two band-pass filters (BPF) 142A and 142B, which respectively keep a 6.5 MHz analog communication signal to the command parsing circuit 143 and a 1 GHz analog television signal provided to the television signal processing circuit 144. The 6.5 MHz analog communication signal entering the command parsing circuit 143 is sequentially converted to a digital signal by an analog-to-digital converter (ADC) 143A, down-converted to a baseband signal by a first frequency down conversion circuit 143B, filtered by a low-pass filter 143C to remove high-frequency noise, and undergoes content parsing by a decoder 143D. The 1 GHz analog television signal entering the television signal processing circuit 144 is first down-converted to a baseband signal by a second frequency down conversion circuit 144A, converted to a digital signal by an ADC 144B, and undergoes other image processing processes.

Among the three types of signals transmitted through the cable 130, the carrier frequency of the television signals is higher, whereas the carrier frequencies of the communication signals and the request signals are lower and are close to each other. As shown in FIG. 2, the low-pass filter 141A and the diplexer 143 are connected to the cable 130 by the same wire. To prevent the 4.5 MHz request signal sent by the low-pass filter 141D from interfering the 6.5 MHz communication signals of the command parsing circuit 143, the frequency band of the band-pass filter 142A needs to be quite narrow in order to allow the 6.5 MHz communication signals to pass through and to remove the 4.5 MHz request signals at the same time. According to the above technical requirements, the diplexer 142 is usually implemented by a costly device having a large volume outside the chip.

### SUMMARY OF THE INVENTION

The invention is directed to a circuit structure for a television signal receiving to solve the above issues.

A television signal receiving apparatus cooperating with a front-end circuit in a frequency division full-duplex satellite television system is provided according to an embodiment of the present invention. The front-end circuit provides a television signal and a communication signal. The television signal receiving apparatus includes a request generating circuit, a command parsing circuit and a television signal processing circuit. The request generating circuit includes an information processing circuit, a mixer, a digital-to-analog conversion circuit and a multi-node low-pass filter (LPF). The information processing circuit generates a string of data bits representing a request signal. The mixer mixes the string of data bits to generate a mixing result. The digital-to-analog conversion circuit performs digital-to-analog conversion on the mixing result to generate an analog request signal. The multi-node LPF has a first terminal, a second terminal and a third terminal. The first terminal receives the analog request signal, the second terminal is electrically coupled to the command parsing circuit, and the third terminal is electrically coupled to the front-end circuit. The multi-node LPF filters out high-frequency signals coupled from the first terminal and the third terminal to the second terminal, and further filters out high-frequency signals coupled from the first terminal to the third terminal. A cut-off frequency of the multi-node LPF is associated with a frequency of the analog request signal and a frequency at which the front-end circuit provides the communication signal. The command parsing circuit is electrically coupled to the second terminal of the multi-node LPF, receives a filtered signal from the second terminal, and processes and parses the filtered signal. The television signal processing circuit receives and processes the television signal from the front-end circuit.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a function block diagram of a satellite television signal receiving end;

FIG. 2 (prior art) is a partial circuit function block diagram of a current television signal receiving apparatus;

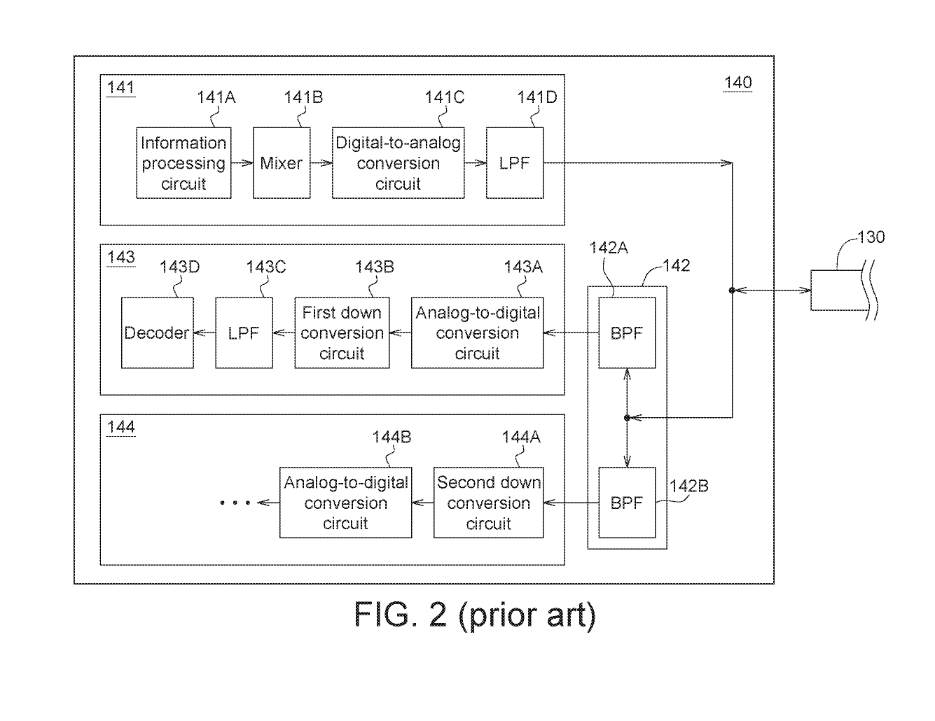

FIG. 3 is a function block diagram of a television signal receiving apparatus according to an embodiment of the present invention; and

FIG. 4 is a detailed implementation example of a multi-node low-pass filter according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

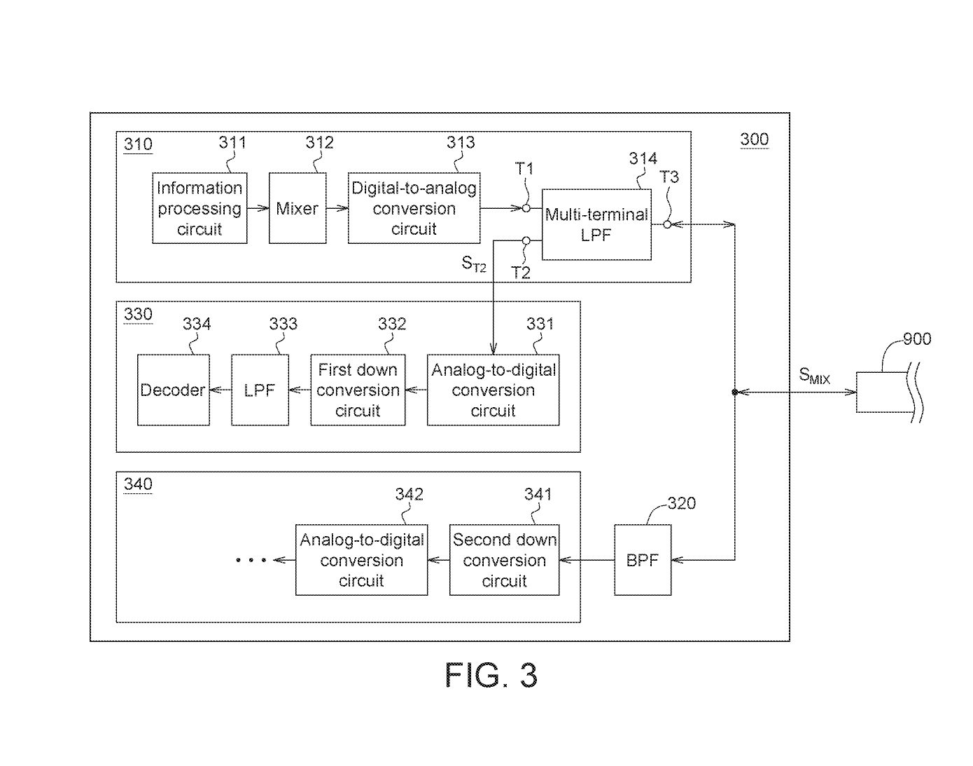

FIG. 3 shows a function block diagram of a television signal receiving apparatus in a frequency division full-duplex satellite television system according to an embodiment of the present invention. A television signal receiving apparatus 300 includes a request generating circuit 310, a band-pass filter (BPF) 320, a command parsing circuit 33, and a television signal processing circuit 340. The request generating circuit 310 belongs to a transmitting circuit in the television signal receiving apparatus 300, and the BPF 320, the command parsing circuit 330 and the television signal processing circuit 340 belong to a receiving circuit in the television signal receiving apparatus 300. Operation details of these circuits are given below.

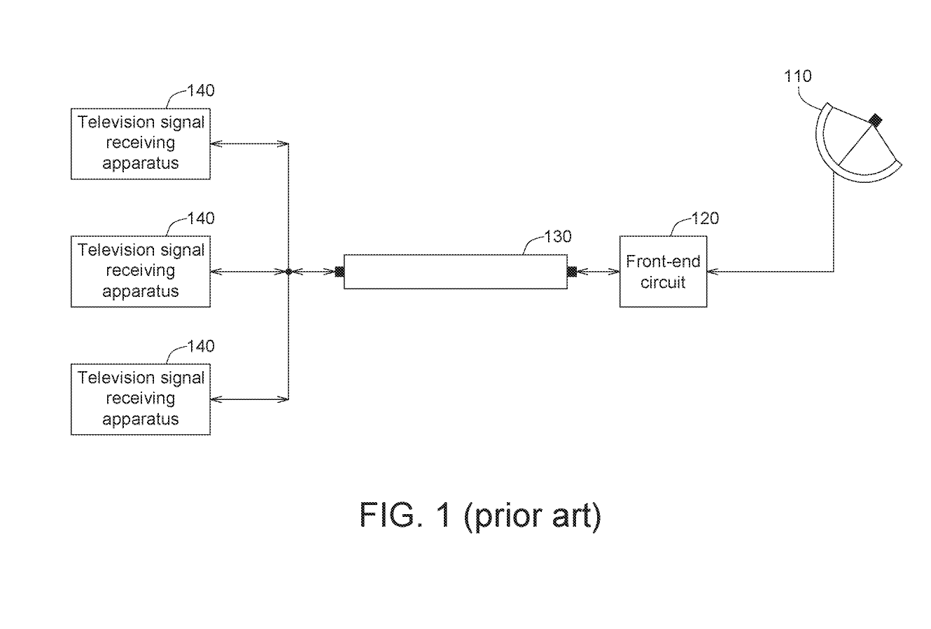

The television signal receiving apparatus 300 is connected to a front-end circuit (e.g., the circuit 120 in FIG. 1, not shown) through a cable 900. Based on characteristics of a frequency division full-duplex system, a mixing signal S_{MIX} in FIG. 3 may at the same time include a television signal and a communication signal sent by the front-end circuit to the television signal receiving apparatus 300, and a request signal sent by the television signal receiving apparatus 300 to the front-end circuit. For illustration purposes, in the embodiment below, it is assumed that the television signal is carried in a frequency band near 1 GHz, the communication signal sent by the front-end circuit to the television signal receiving apparatus 300 is carried in a frequency band near 6.5 MHz, and the request signal sent by the television signal receiving apparatus 300 to the front-end circuit is carried in a frequency band near 4.5 MHz.

The request generating circuit 310 includes an information processing circuit 311, a mixer 312, a digital-to-analog conversion circuit 313, and a multi-node low-pass filter (LPF) 314. When a request is to be sent to the front-end circuit, the information processing circuit 311 provides a string of data bits representing the request signal to the mixer 312 and to the digital-to-analog conversion circuit 313 to generate an analog request signal carried at 4.5 MHz. As shown in FIG. 3, the multi-node LPF 314 has a first node T1, a second node T2 and a third node T3. The first node T1 is electrically coupled to the digital-to-analog conversion circuit 313, the second node T2 is electrically coupled to the command parsing circuit 330, and the third node T3 is electrically coupled to the cable 900 (thereby connecting to the front-end circuit). The multi-node LPF 314 filters out high-frequency signals from the first node T1 that is possibly coupled to the third node T3, and further filters out high-frequency signals respectively from the first node T1 and the third node T3 that are possibly coupled to the second node T2. More specifically, one function of the multi-node LPF 314 is to filter out high-frequency harmonics in the analog request signal generated by the digital-to-analog conversion circuit 313, preventing the high-frequency harmonics from coupling to the second terminal T2 and to the third node T3, from the first node T1. Another function of the multi-node LPF 314 is to filter out the television signal from the front-end circuit, preventing the television signal from coupling to the second node T2, which results in interfering the command parsing circuit 330.

Thus, the cut-off frequency of the multi-node LPF 314 may be determined according to the frequency of the request signal (from the digital-to-analog conversion circuit 313) and the frequency of the communication signal (from the front-end circuit to the television signal receiving apparatus 300). In an example where the frequency of the request signal is 4.5 MHz and the frequency of the communication signal is 6.5 MHz, the cut-off frequency of the multi-node LPF 314 may be set to block signals higher than 8 MHz from coupling to the second node T2 and the third node T3.

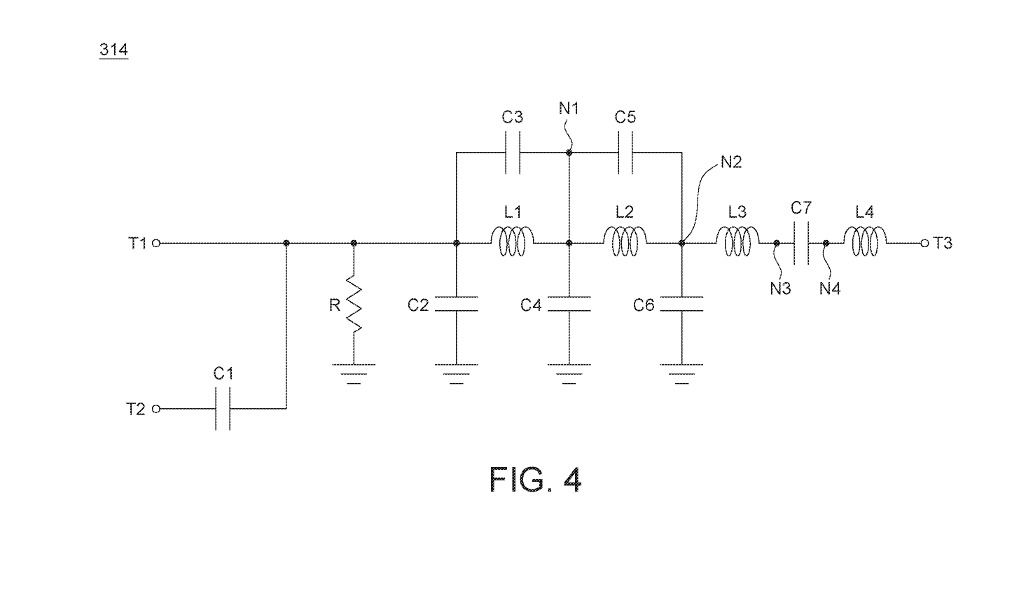

FIG. 4 shows a detailed implementation example of the multi-node LPF 314 including one resistor, seven capacitors and four inductors. The first capacitor C1 is electrically coupled between the first node T1 and the second node T2. The resistor R and the second capacitor C2 are coupled in parallel between the first node T1 and a ground node. The first inductor L1 and the third capacitor C3 are coupled in parallel between a first internal node N1 and the first node T1. The fourth capacitor C4 is electrically coupled between the first internal node N1 and the ground node. The second inductor L2 and the fifth capacitor C5 are coupled in parallel between the first internal node N1 and a second internal node N2. The sixth capacitor C6 is electrically coupled between the second internal node N2 and the ground node. The third inductor L3 is electrically coupled between the second internal node N2 and a third internal node N3. The seventh capacitor C7 is electrically coupled between the third internal node N3 and a fourth internal node N4. The fourth inductor L4 is electrically coupled between the fourth internal node N4 and the third node T3. If the goal is to achieve “blocking coupling of a frequency higher than 8 MHz to the second node T2 and third node T3”, the value of the resistor R may be set to 75Ω, the values of the capacitors C1 to C7 are respectively set to 0.1 μF, 1 nF, 0.22 nF, 2.2 nF, 0.12 nF, 2 nF and 0.1 μF, and the values of the inductors L1 to L4 are respectively set to 9.9 μH, 4.7 μH, 4.7 μH and 0.16 μH.

As shown in FIG. 3, the command parsing circuit 330 includes an analog-to-digital conversion circuit 331, a first down conversion circuit 332, a digital low pass filter (LPF) 333 and a decoder 334 A signal S_{T2} sequentially undergoes analog-to-digital conversion performed by the analog-to-digital conversion circuit 331, frequency down conversion performed by the first down conversion circuit 332, low-pass filtering performed by the digital LPF 333, and content parsing performed by the decoder 334. It should be noted that, various satellite systems may demand different specifications for the format of the communication signal, and means for content parsing does not form a limitation on the scope of the present invention and are not further discussed herein.

Under the effect of the multi-node LPF 314, the signal S_{T2} at the second node T2 does not include the television signal sent by the front-end circuit to the television signal receiving apparatus 300. However, the signal ST2 nonetheless includes two carrier signals, which are respectively the request signal carried at 4.5 MHz and the communication signal carried at 6.5 MHz. The first down conversion circuit 332 down converts by means of mixing according to the carrier frequency (6.5 MHz) of the communication signal, such that the communication signal in the signal S_{T2} is shifted to around the baseband (having a 0 frequency) and 13 (=6.5+6.5) MHz on the spectrum. On the other hand, the 4.5 MHz request signal in the signal ST2 is shifted to around −2 (=4.5-6.5) MHz and 11 (=4.5+6.5) MHz on the spectrum. To obtain the baseband communication signal after the frequency down conversion, the digital LPF 333 needs to filter out the above signals at −2 MHz, 11 MHz and 13 MHz, particularly the −2 MHz signal, which is closest to the baseband. It is seen from the above description that, the cut-off frequency of the digital LPF 333 is associated with a frequency difference between the request signal and the communication signal. In practice, the number of taps of the digital LPF 333 may be appropriately set to reinforce the attenuation effect on the −2 MHz signal.

On the other hand, the BPF 320 filters the signals to provide the 1 GH television signal to the television signal processing circuit 340. The television signal carried at 1 GHz inputted to the television signal processing circuit 340 is sequentially shifted to baseband by a second down conversion circuit 341, and then is converted to a digital signal by an analog-to-digital conversion circuit 342, and undergoes other image processing processes. It should be noted that, the image processing procedure of the television signal is common knowledge to one person skilled in the art, and shall be omitted herein.

As seen from the above embodiments, it is not necessary to apply diplexer in the television signal receiving apparatus 300 as in the prior art. Instead, it is configured to have the request generating circuit 310 and the command parsing circuit 330 share one multi-node LPF. Thus, the television signal receiving apparatus 300 eliminates the issue a diplex implemented by a costly chip of the prior art.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A television signal receiving apparatus cooperating with a front-end circuit in a frequency division full-duplex satellite television system, the front-end circuit providing a television signal and a communication signal, the television signal receiving apparatus comprising:
a request generating circuit, comprising:
a signal processing circuit, generating a string of data bits representing a request signal;
a mixer, performing mixing on the string of data bits to generate a mixing result;
a digital-to-analog conversion circuit, performing digital-to-analog conversion on the mixing result to generate an analog request signal; and
a multi-node low-pass filter (LPF), having a first node, a second node and a third node, the first node receiving the analog request signal, the third node electrically coupled to the front-end circuit, the multi-node LPF filtering out high-frequency signals flowing from the first node and the third node to the second node and further filtering out high-frequency signals flowing from the first node to the third node, a cut-off frequency of the multi-node LPF being associated with a carrier frequency of the analog request signal and a carrier frequency of the communication signal;
a command parsing circuit, electrically coupled to the second node of the multi-node LPF, receiving a filtered signal from the second node, and processing and parsing the filtered signal; and
a television signal processing circuit, receiving and processing the television signal provided by the front-end circuit.

2. The television signal receiving apparatus according to claim 1, wherein the command parsing circuit comprises:
an analog-to-digital conversion circuit, electrically coupled to the second node of the multi-node LPF, performing analog-to-digital conversion on the filtered signal to generate a digital signal;
a down conversion circuit, electrically coupled to the analog-to-digital conversion circuit, performing frequency down conversion on the digital signal according to the frequency of the communication signal to generate a down converted signal; and
a digital LPF, electrically coupled to the down conversion circuit, performing low-pass filtering on the down converted signal, wherein a cut-off frequency of the digital LPF is associated with a frequency difference between the carrier frequencies of the request signal and the communication signal.

3. The television signal receiving apparatus according to claim 1, wherein the multi-node LPF comprises:
a first capacitor, electrically coupled between the first node and the second node of the multi-node LPF;
a resistor, electrically coupled between the first node of the multi-node LPF and a ground node;
a second capacitor, electrically coupled between the first node of the multi-node LPF and the ground node;
a first inductor, electrically coupled between a first internal node and the first node of the multi-node LPF;
a third capacitor, electrically coupled between the first internal node and the first node of the multi-node LPF;
a fourth capacitor, electrically coupled between the first internal node and the ground node;
a second inductor, electrically coupled between the first internal node and a second internal node;
a fifth capacitor, electrically coupled between the first internal node and the second internal node;
a sixth capacitor, electrically coupled between the second internal node and the ground node;
a third inductor, electrically coupled between the second internal node and a third internal node;
a seventh capacitor, electrically coupled between the third internal node and a fourth internal node; and
a fourth inductor, electrically coupled between the fourth internal node and the third node of the multi-node LPF.
